(19) United States
(12) Patent Application Publication
(10) Pub. No.: US 2009/0060608 A1
(43) Pub. Date: Mar. 5, 2009

(54) Image forming apparatus

(75) Inventors: Yutaka Shoji, Ibaraki (JP); Junji Shirakawa, Ibaraki (JP); Takayuki Muneyasu, Ibaraki (JP)

Correspondence Address: HARNESS, DICKEY & PIERCE, P.L.C., P.O. BOX 8910, RESTON, VA, 20195, US

(73) Assignee: RICOH COMPANY, LIMITED

(21) Appl. No.: 12/219,814

(22) Filed: Jul. 29, 2008

(30) Foreign Application Priority Data
Aug. 30, 2007 (JP) 2007-224215

(51) Int. Cl. G03G 15/00

(52) U.S. Cl. 399/394

(57) ABSTRACT

An image forming apparatus includes an image transfer unit, a straight conveying path including a lateral registration correcting unit, a feeding unit, a feeding path, and a reversing unit. The feeding path links to a junction in the straight conveying path, and conveys a recording medium from a feeding unit to the junction. The feeding path is arranged on an inner side of the image forming apparatus than an end of an upstream side of the straight conveying path in the conveying direction is.

### CROSS-REFERENCE TO RELATED APPLICATIONS

The present application claims priority to and incorporates by reference the entire contents of Japanese priority document 2007-224215 filed in Japan on Aug. 30, 2007.

### BACKGROUND OF THE INVENTION

1. Field of the Invention

The present invention relates to an image forming apparatus, and more particularly, to a method of correcting lateral registration in an image forming apparatus.

2. Description of the Related Art

In image forming apparatuses, such as a copier or a printer, disclosed in, for example, Japanese Patent Application Laid-open No. 2002-348023 and Japanese Patent Application Laid-open No. 2004-106572, a recording medium is fed from a feeding unit (a sheet tray) arranged in a lower portion of the image forming apparatus, and is conveyed to an image transfer unit through a conveying path in the image forming apparatus. Then, an image carried on an image carrier, such as an intermediate transfer belt, of the image transfer unit is transferred onto the recording medium. In such an image forming apparatus, generally, a straight conveying path is arranged to convey the recording medium to the image transfer unit, and a curved conveying path links the straight conveying path and the feeding unit.

Furthermore, in such an image forming apparatus, when a recording medium is to be conveyed to the image transfer unit, misalignment of the recording medium in the width direction is corrected (lateral registration correction) in the conveying path, so that an image carried on the image carrier is transferred onto a correct position of the recording medium by the image transfer unit.

For example, Japanese Patent No. 2893540 discloses a technology in which, after the leading edge of a recording medium is brought into contact with a contact member (a gate member) and is set in a position, registration rollers arranged downstream of the contact member move in the width direction while holding the recording medium, so that misalignment of the recording medium is corrected in the width direction (in a direction perpendicular to a conveying direction of the recording medium). The recording medium is then conveyed to the image transfer unit.

In the conventional image forming apparatuses described above, to correct the misalignment of the recording medium in the width direction with high precision, a lateral registration correcting unit that performs the lateral registration correction needs to be arranged in the straight conveying path. This causes a problem that the image forming apparatus becomes bulky.

Specifically, the lateral registration correction of the recording medium needs to be performed in a state that the recording medium lies flat without being curved, so that the lateral registration correcting unit corrects the misalignment of the recording medium in the width direction with high precision. Therefore, the straight conveying path including the lateral registration correcting unit is arranged, and the curved conveying path links the feeding unit and an upstream side of the straight conveying path. As a result, the total size of the conveying path (the straight conveying path and the curved conveying path) of the image forming apparatus becomes large in the lateral direction, and therefore it is difficult to make the size of the image forming apparatus compact. Especially, in the case of a large-sized image forming apparatus in which the maximum size of a recording medium to be conveyed is set to a relatively large size, a size of the straight conveying path becomes large, and it is difficult to reduce the size of the image forming apparatus.

### SUMMARY OF THE INVENTION

It is an object of the present invention to at least partially solve the problems in the conventional technology.

According to an aspect of the present invention, there is provided an image forming apparatus including an image transfer unit that transfers an image carried on an image carrier onto a recording medium; a feeding unit that feeds the recording medium; a conveying path that conveys a recording medium from the feeding unit to the image transfer unit, the conveying path including a first conveying path, a second conveying path, and a coupling unit that couples the first conveying path and the second conveying path to each other, the first conveying path connecting the feeding unit to the coupling unit, the second conveying path connecting the coupling unit to the image transfer unit, and the first conveying path being substantially straight; a lateral registration correcting unit arranged in the second conveying path downstream of the coupling unit and that corrects misalignment of the recording medium in a width direction of the recording medium when the recording medium is being conveyed through the second conveying path; and a reversing unit that receives the recording medium conveyed to the coupling unit through the first conveying path, reverses a conveying direction of the recording medium and feeds the recording medium to the coupling unit so that the recording medium is conveyed to the image transfer unit through the second conveying path, wherein the first conveying path is arranged on an inner side of the image forming apparatus than an end of the second conveying path upstream of the coupling unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of an image forming apparatus according to an embodiment of the present invention;

FIG. 2 is an enlarged view of an image forming unit of the image forming apparatus;

FIG. 3 is a schematic diagram of a part of the image forming apparatus near a straight conveying path and a feeding path;

FIG. 4 is a top view of the straight conveying path in a width direction;

FIGS. 5A to 5C are schematic diagrams of the feeding path and the straight conveying path for explaining 5. movement of a recording medium;

FIGS. 6A to 6D and FIGS. 7A to 7D are schematic diagrams of the straight conveying path for explaining movement of the recording medium;

FIG. 8 is a schematic diagram of the feeding path and the straight conveying path;

FIG. 9 is a schematic diagram of another example of the feeding path and the straight conveying path; and

FIG. 10 is a schematic diagram of a conventional image forming apparatus near a conveying path.

### DETAILED DESCRIPTION OF THE PREFERRED EMBODIMENTS

Exemplary embodiments of the present invention are explained in detail below with reference to the accompanying drawings. The same or corresponding components are indicated by the same reference numeral in the drawings, and explanation thereof is simplified or omitted as appropriate.

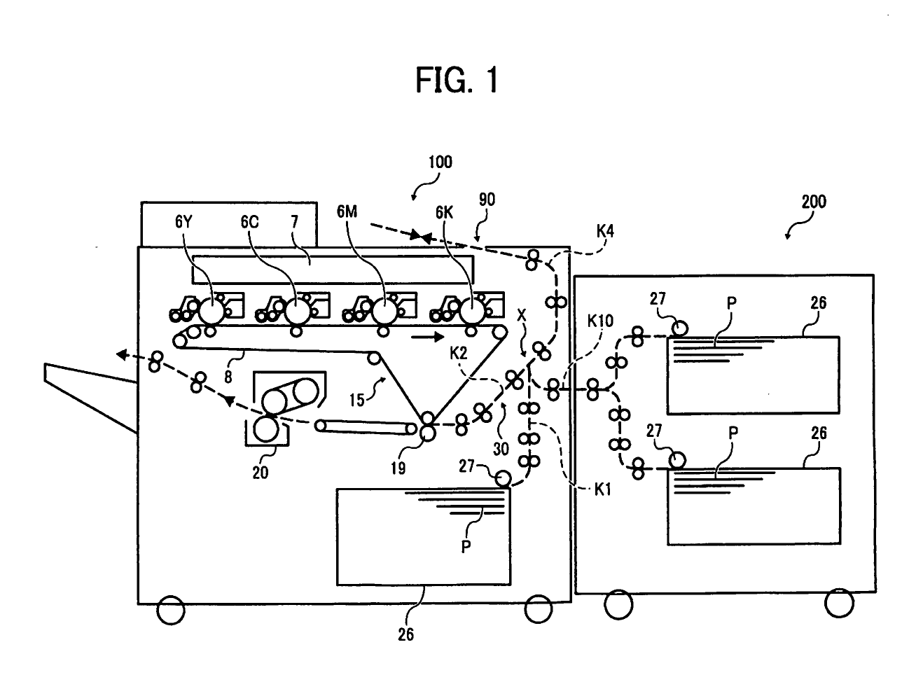

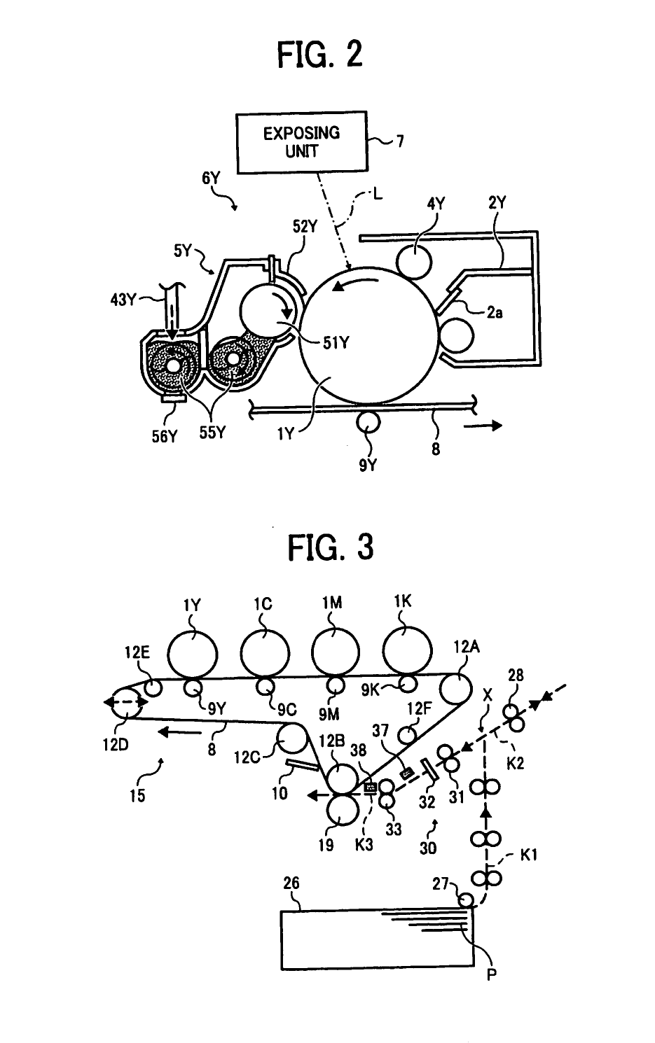

FIG. 1 is a schematic diagram of an image forming apparatus 100 according to an embodiment of the present invention. FIG. 2 is an enlarged view of an image forming unit 6Y of the image forming apparatus 100. Although the image forming apparatus 100 is explained below as a printer, the image forming apparatus 100 can be a copier, a facsimile machine, or a multifunction product (MFP).

As shown in FIG. 1, the image forming apparatus 100 includes an intermediate-transfer belt device 15, image forming units 6Y, 6C, 6M, and 6K, a registration correcting unit 30, and a feeding unit 26. The intermediate-transfer belt device 15 is arranged in the center of a main body of the image forming apparatus 100. The image forming units 6Y, 6C, 6M, and 6K correspond to colors of yellow, cyan, magenta, and black, respectively, and are arranged in parallel to an intermediate transfer belt 8 of the intermediate-transfer belt device 15. The registration correcting unit 30 serves as a lateral registration correcting unit, and is arranged in a straight conveying path K2 on the lower right side of the intermediate-transfer belt device 15. The feeding unit 26 contains a recording medium P, and is arranged under the straight conveying path K2.

It is possible to connect a large-capacity tray (LCT) 200 serving as a feeding device to the image forming apparatus 100 so that the recording medium P can be fed from the outside of the image forming apparatus 100.

As shown in FIG. 2, the image forming unit 6Y includes a photosensitive drum 1Y, a charging unit 4Y, a developing unit 5Y, a cleaning unit 2Y, and a neutralizing unit (not shown). The charging unit 4Y, the developing unit 5Y, the cleaning unit 2Y, and the neutralizing unit are arranged around the photosensitive drum 1Y. An image forming process (a charging process, an exposing process, a developing process, a transferring process, and a cleaning process) is performed on the photosensitive drum 1Y, so that a yellow image is formed on the photosensitive drum 1Y.

The image forming units 6C, 6M, and 6K have almost the same configuration as that of the image forming unit 6Y except that they contain a toner of different color. In other words, the image forming units 6Y, 6C, 6M, and 6K form toner images of respectively different colors. In the following description, explanations about the image forming units 6C, 6M, and 6K will be omitted as appropriate, and only the image forming unit 6Y will be explained.

The photosensitive drum 1Y is driven to rotate by a drive motor (not shown) in the counterclockwise direction indicated by an arrow in FIG. 2. The surface of the photosensitive drum 1Y is uniformly charged by the charging unit 4Y (the charging process).

Then, the surface of the photosensitive drum 1Y is irradiated and scanned with a laser beam L emitted from an exposing unit 7 whereby an electrostatic latent image corresponding to the yellow color is formed on the surface of the photosensitive drum 1Y (the exposing process).

Afterward, the electrostatic latent image formed on the surface of the photosensitive drum 1Y is developed by the developing unit 5Y, so that a yellow toner image is formed on the surface of the photosensitive drum 1Y (the developing process).

Then, the toner image formed on the surface of the photosensitive drum 1Y is transferred onto the intermediate transfer belt 8 by a transfer roller 9Y (a primary transfer process). At this process, residual toner remains on the photosensitive drum 1Y.

Then, the residual toner on the surface of the photosensitive drum 1Y is removed by a cleaning blade 2a of the cleaning unit 2Y, and the removed toner is collected in the cleaning unit 2Y (the cleaning process).

Finally, residual charges remaining on the surface of the photosensitive drum 1Y are removed by the neutralizing unit.

Then, the image forming process performed on the photosensitive drum 1Y is completed.

The image forming process described above is performed by the image forming units 6C, 6M, and 6K in the same manner as the image forming unit 6Y does. Specifically, the laser beam L is emitted from the exposing unit 7 based on image data, and then photosensitive drums 1C, 1M, and 1K of the image forming units 6C, 6M, and 6K are irradiated with the laser beam L. More specifically, the laser beam L is emitted from a light source (not shown) in the exposing unit 7, and the emitted laser beam L is deflected by a rotating polygon mirror (not shown) whereby the photosensitive drums 1C, 1M, and 1K are irradiated with the deflected laser beam L via a plurality of optical elements.

Then, the four color toner images formed on the photosensitive drums 1Y, 1C, 1M, and 1K in the developing process are transferred onto the intermediate transfer belt 8 serving as an image carrier in a superimposed manner. Thus, a color image is formed on the intermediate transfer belt 8.

FIG. 3 is a schematic diagram of a part of the image forming apparatus 100 near the straight conveying path K2 and a feeding path K1. The intermediate-transfer belt device 15 includes the intermediate transfer belt 8, four transfer rollers 9Y, 9C, 9M, and 9K, a drive roller 12A, an opposing roller 12B, supporting rollers 12C to 12F, and an intermediate-transfer cleaning unit 10. The intermediate transfer belt 8 is supported by the rollers 12A to 12F, and is endlessly moved in a direction indicated by an arrow in FIG. 3 in accordance with rotation of the drive roller 12A.

The transfer rollers 9Y, 9C, 9M, 9K, and the photosensitive drums 1Y, 1C, 1M, 1K hold the intermediate transfer belt 8 therebetween, thereby forming primary transfer nips. A transfer voltage (transfer bias) with a reverse polarity with respect to a polarity of toner is applied to each of the transfer rollers 9Y, 9C, 9M, and 9K.

The intermediate transfer belt 8 (belt-shaped image carrier) moves in the direction indicated by the arrow in FIG. 3, and sequentially passes through the primary transfer nips between the transfer rollers 9Y, 9C, 9M, 9K, and the photosensitive drums 1Y, 1C, 1M, 1K. In this manner, the four color toner images formed on the photosensitive drums 1Y, 1C, 1M, and 1K are primary-transferred onto the intermediate transfer belt 8 in a superimposed manner whereby a color image is formed on the intermediate transfer belt 8.

The color image formed on the intermediate transfer belt 8 reaches an opposing position at which the intermediate transfer belt 8 is arranged in parallel to a secondary transfer roller 19 (an image transfer unit). The opposing roller 12B and the secondary transfer roller 19 sandwiches the intermediate transfer belt 8 therebetween at the opposing position, thereby forming a secondary transfer nip (the image transfer unit). The color image formed on the intermediate transfer belt 8 is transferred onto the recording medium P, such as a transfer sheet, when the recording medium P is conveyed through the secondary transfer nip (a secondary transfer process). At this process, residual toner that is not transferred onto the recording medium P remains on the intermediate transfer belt 8.

The residual toner on the intermediate transfer belt 8 is removed by the intermediate-transfer cleaning unit 10.

Then, the transferring process performed on the intermediate transfer belt 8 is completed.

As shown in FIG. 1, the recording medium P is fed by a feeding roller 27 from the feeding unit 26 arranged in a lower portion of the image forming apparatus 100 (or the feeding unit 26 in the LCT 200 arranged on the side of the image forming apparatus 100), and is conveyed to the secondary transfer nip through the feeding path K1 (or a second feeding path K10) and the straight conveying path K2.

Specifically, the feeding unit 26 contains a plurality of recording media P, such as transfer sheets, in a stacked manner. When the feeding roller 27 is driven to rotate in the counterclockwise direction in FIG. 1, the uppermost recording medium P in the feeding unit 26 is fed by the feeding roller 27 and is conveyed to the feeding path K1. The recording medium P in the feeding path K1 is then conveyed to the straight conveying path K2 through a junction X (arranged upstream of the registration correcting unit 30), and is conveyed in the straight conveying path K2 in such a direction that the recording medium P is moved away from the registration correcting unit 30 (in the upper-right direction in FIG. 1). After the trailing edge of the recording medium P is conveyed within the straight conveying path K2, the conveying direction of the recording medium P is reversed (switched back), and the recording medium P is conveyed toward the registration correcting unit 30.

After skew correction (slant correction), lateral registration correction (correction of misalignment in a width direction of the recording medium P), and longitudinal registration correction (correction of misalignment in a conveying direction of the recording medium P) are performed on the recording medium P by the registration correcting unit 30, the recording medium P is conveyed to the secondary transfer nip (the image transfer unit) in synchronization with a timing of transferring a color image formed on the intermediate transfer belt 8. In this manner, the color image is transferred onto the recording medium P. The configurations and operations of the feeding path K1 and the straight conveying path K2 will be described in detail later with reference to FIGS. 3 to 7D.

After the color image is transferred onto the recording medium P in the secondary transfer nip, the recording medium P is conveyed to a fixing unit 20 where the color image is fixed on the recording medium P by a fixing belt and a pressing roller with heat and pressure.

Then, the recording medium P is discharged outside of the image forming apparatus 100 by a discharging roller. The recording media P discharged by the discharging roller are sequentially stacked on a stacking unit as output images.

Thus, the image forming process is completed by the image forming apparatus 100. A process line speed (a moving speed of the intermediate transfer belt 8 or a conveying speed of the recording medium P) of the image forming apparatus 100 can be set to, although not limited, about 400 millimeters per second.

As shown in FIG. 1, the feeding path K1 links to a midstream (the junction X) of the straight conveying path K2 including the registration correcting unit 30. Moreover, the feeding path K1 is arranged on the inner side (the left side in FIG. 1) of the image forming apparatus 100 than the end of an upstream side K2a (see FIGS. 5A to 5C) (the upper-right side of the image forming apparatus 100 in FIG. 1) of the straight conveying path K2 in the conveying direction is. With this configuration, the size of the image forming apparatus 100 can be reduced in the lateral direction.

Furthermore, the straight conveying path K2 is tilted such that the upstream side K2a is located at a position higher than a downstream side K2b (see FIGS. 5A to 5C) in the conveying direction. With this arrangement, a useless space between the intermediate-transfer belt device 15 and the straight conveying path K2 can be decreased, and the size of the straight conveying path K2 can be reduced in the lateral direction. Moreover, a space under the straight conveying path K2 can be large, and therefore, it is possible to improve flexibility in layout of the feeding unit 26 arranged under the straight conveying path K2.

In addition, a curved conveying path K4 is arranged upstream of the straight conveying path K2 in the conveying direction. Furthermore, an opening 90 is formed upstream of the straight conveying path K2 in the conveying direction (on an upstream side of the curved conveying path K4). The opening 90 is formed to open to the outside of the image forming apparatus 100 (on an upper side of the image forming apparatus 100). With this configuration, it is possible to convey the recording medium P having a large size in the conveying direction (for example, a banner sheet) without increasing the size of the image forming apparatus 100 in the lateral direction. Specifically, in a case where the recording medium P having a large size in the conveying direction is conveyed, after the recording medium P is temporarily conveyed to the upstream side K2a and the curved conveying path K4 (in some cases, a part of the recording medium P is exposed to the outside of the image forming apparatus 100 through the opening 90), the conveying direction of the recording medium P is reversed, so that the recording medium P is conveyed toward the registration correcting unit 30.

As shown in FIG. 2, the developing unit 5Y includes a developing roller 51Y, a doctor blade 52Y, two conveying screws 55Y, a toner supply path 43Y, and a concentration detecting sensor 56Y. The developing roller 51Y is arranged in parallel to the photosensitive drum 1Y, and the doctor blade 52Y is arranged in parallel to the developing roller 51Y. The conveying screws 55Y are arranged inside a developer container. The toner supply path 43Y communicates with the developer container through an opening. The concentration detecting sensor 56Y detects a concentration of toner contained in a developer. The developing roller 51Y includes a magnet (not shown) that is fixedly mounted in the developing roller 51Y and a sleeve (not shown) that is rotated around the magnet. The developer container contains a two-component developer composed of carrier and toner.

The sleeve of the developing roller 51Y is rotated in a direction indicated by an arrow in FIG. 2. Developer carried on the developing roller 51Y due to a magnetic field generated by the magnet moves on the developing roller 51Y in accordance with rotation of the sleeve. The developer contained in the developing unit 5Y is adjusted such that a ratio of toner in the developer (a toner concentration) is set within a predetermined range.

Toner supplied to the developer container is mixed and stirred with the developer by the conveying screws 55Y, and circulates in two separated sections of the developer container (in a direction perpendicular to a sheet surface of FIG. 2). The toner in the developer is then adhered to carrier due to a frictional charge between the toner and the carrier, and the toner is carried on the developing roller 51Y together with the carrier by a magnetic force generated on the developing roller 51Y.

The developer carried on the developing roller 51Y is conveyed in the direction indicated by the arrow in FIG. 2 to reach the doctor blade 52Y. After an amount of the developer on the developing roller 51Y is adjusted to an appropriate amount by the doctor blade 52Y, the developer is conveyed to an opposing position (a developing area) at which the developing roller 51Y is arranged in parallel to the photosensitive drum 1Y. The toner is then adhered to a latent image formed on the photosensitive drum 1Y by an electric field generated on the developing area. Afterward, the developer remaining on the developing roller 51Y moves to an upper portion of the developer container in accordance with rotation of the sleeve, and then separates from the developing roller 51Y.

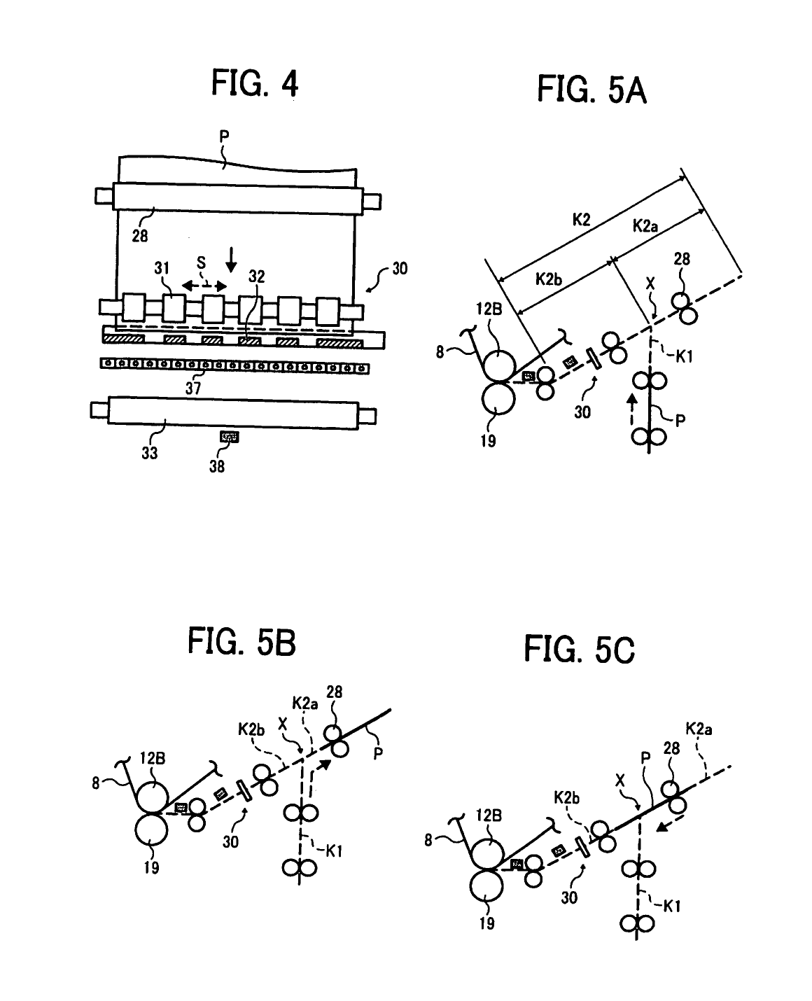

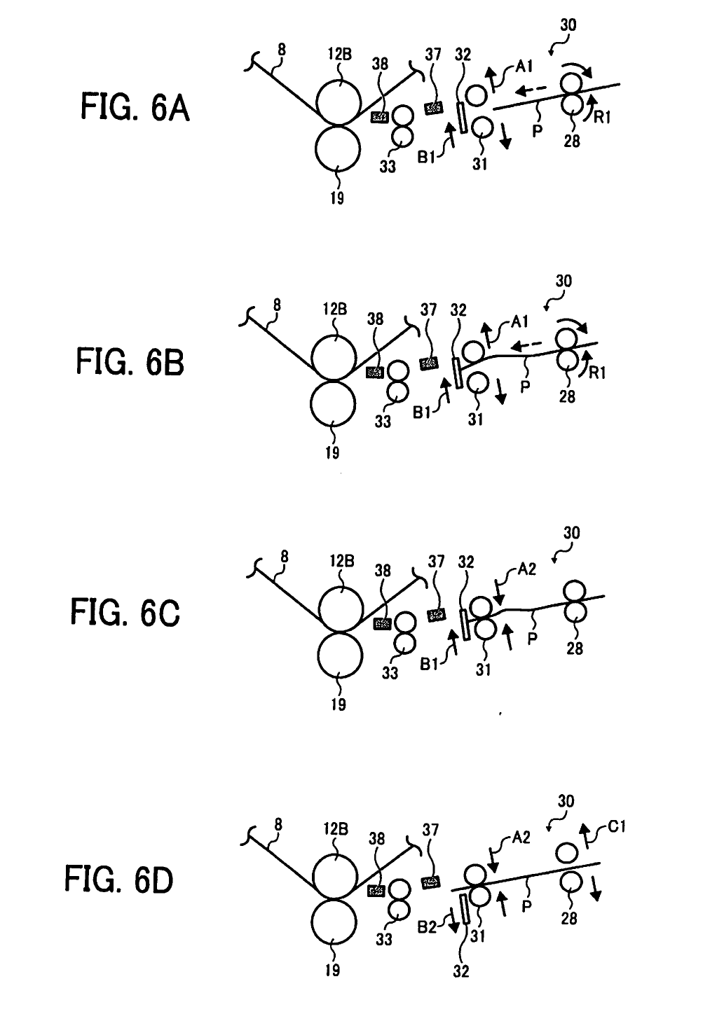

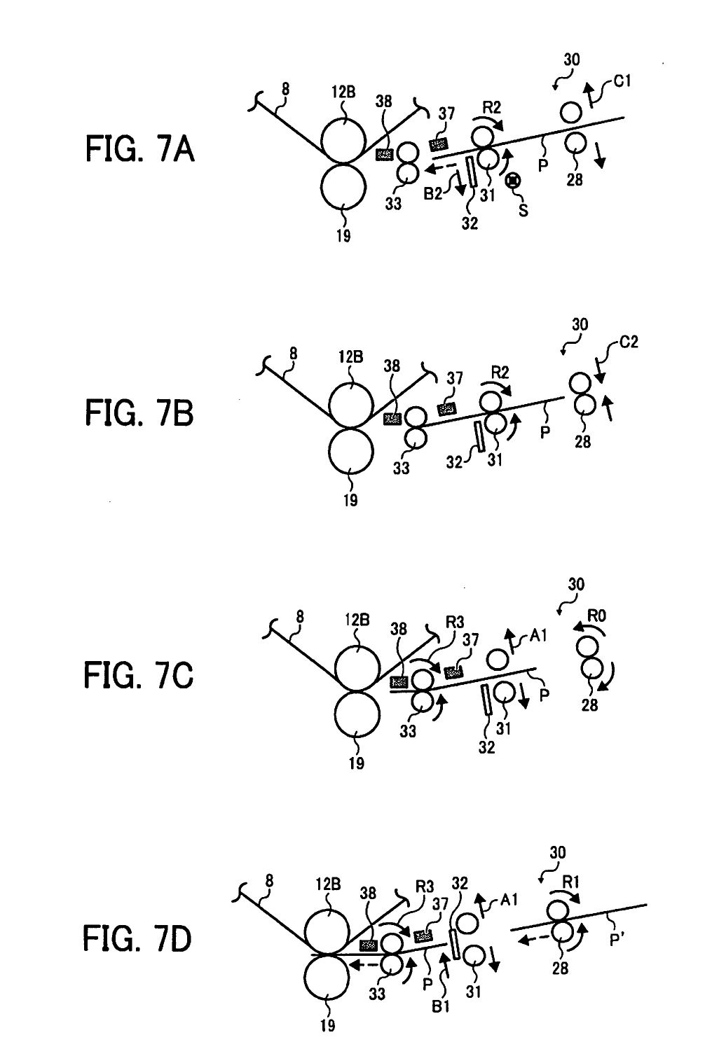

FIG. 4 is a top view of the straight conveying path K2 in the width direction. FIGS. 5A to 5C are schematic diagrams of the feeding path K1 and the straight conveying path K2 for explaining movement of the recording medium P. FIGS. 6A to 6D and FIGS. 7A to 7D are schematic diagrams of the straight conveying path K2 for explaining movement of the recording medium P.

As shown in FIGS. 3 and 4, the straight conveying path K2 includes conveying rollers 28 serving as a reversing unit, the junction X, and the registration correcting unit 30. The registration correcting unit 30 includes holding rollers 31 serving as a lateral registration correcting unit, a contact member 32, and registration rollers 33 serving as a longitudinal registration correcting unit. The holding rollers 31, the contact member 32, and the registration rollers 33 are sequentially arranged from an upstream side of the registration correcting unit 30. A contact image sensor (CIS) 37 is arranged between the contact member 32 and the registration rollers 33. Furthermore, a photosensor 38 is arranged between the registration rollers 33 and the secondary transfer nip (the image transfer unit).

Specifically, the registration rollers 33 are arranged upstream of the secondary transfer nip in the conveying direction. The straight conveying path K2 is arranged upstream of the registration rollers 33 in the conveying direction, and is tilted downward from the upstream side K2a to the downstream side K2b. In addition, a conveying path K3 is arranged so that an area from the registration rollers 33 to the secondary transfer nip is horizontal.

With this configuration, a useless space between the intermediate transfer belt 8 (a surface of the intermediate transfer belt 8) and the registration correcting unit 30 can be reduced. Furthermore, because the recording medium P is not conveyed to the secondary transfer nip at a sharp angle, a color image can be secondary-transferred onto the recording medium P in a stable manner.

The conveying rollers 28 are arranged upstream of the junction X in the conveying direction of the recording medium P. The conveying rollers 28 include an upper conveying roller and a lower conveying roller, and they can be moved into contact with or away from each other by a drive mechanism (not shown).

The conveying rollers 28 are rotatable in forward and backward directions by a drive motor (not shown). Although not shown, a switching claw is arranged in the junction X to switch the conveying direction of the recording medium P (switch between the direction from the feeding path K1 to the upstream side K2a and the direction from the upstream side K2a to the downstream side K2b).

When the recording medium P is conveyed from the feeding path K1 to the junction X, the conveying rollers 28 are rotated in the forward direction to convey the recording medium P in the straight conveying path K2 in such a direction that the recording medium P is moved away from the registration correcting unit 30. Afterward, the conveying rollers 28 are rotated in the backward direction to reverse the conveying direction of the recording medium P, so that the recording medium P is conveyed toward the registration correcting unit 30. Thus, the conveying rollers 28 function as the reversing unit.

Although the conveying rollers 28 are arranged in the straight conveying path K2 according to the embodiment, the conveying rollers 28 can be arranged in the curved conveying path K4 that is arranged upstream of the straight conveying path K2.

The contact member 32 is a plate-like member having a contact surface (divided into a plurality of portions in a width direction) with which the leading edge of the recording medium P is brought into contact. The contact member 32 is made of, for example, a metallic material. The leading edge of the recording medium P is brought into contact with the contact member 32, so that skew (slanting) and longitudinal registration of the recording medium P is corrected. The contact member 32 is arranged in the straight conveying path K2 to open and close the straight conveying path K2 through which the recording medium P is passed. Specifically, the contact member 32 is driven by a cam mechanism (not shown) that engages with the contact member 32 such that the contact member 32 is moved upward in FIG. 3 to close the straight conveying path K2 at a predetermined timing, or is moved downward in FIG. 3 to open the straight conveying path K2.

Each of the holding rollers 31 includes a plurality of rollers that is divided in the width direction, and is arranged upstream of the contact member 32 in the conveying direction of the recording medium P. The holding rollers 31 are arranged in the straight conveying path K2. The holding rollers 31 include an upper holding roller and a lower holding roller. The upper holding roller and the lower holding roller can be moved into contact with or away from each other and can be moved in a width direction (in a direction indicated by a two-headed dashed arrow S in FIG. 4) by a drive mechanism (not shown). After the holding rollers 31 hold the recording medium P that is in contact with the contact member 32, the holding rollers 31 move in the width direction, so that the lateral registration of the recording medium P is corrected.

As described above, the conveying rollers 28, the contact member 32, and the holding rollers 31 are arranged in the straight conveying path K2, and the recording medium P lies flat without being curved in the straight conveying path K2, so that the skew correction, the lateral registration correction, and the longitudinal registration correction can be performed on the recording medium P with high precision before an image is transferred onto the recording medium P. Especially, the lateral registration correction can be performed on the recording medium P with higher precision in the straight conveying path K2 compared with a case where the lateral registration correction is performed on the recording medium P in a curved conveying path.

The registration rollers 33 are arranged downstream of the contact member 32 in the conveying direction of the recording medium P. After the lateral registration of the recording medium P is corrected by the holding rollers 31, the recording medium P is brought into contact with a nip between the registration rollers 33 whereby the longitudinal registration of the recording medium P is corrected. Moreover, the leading edge of the recording medium P is in contact with the registration rollers 33, so that the skew of the recording medium P is corrected.

The CIS 37 includes a plurality of photosensors (including a light emitting element such as a light-emitting diode (LED) and a light receiving element such as a photodiode) that is arranged in parallel in a width direction. The CIS 37 detects positions of both ends of the recording medium P in the width direction thereby detecting a degree of misalignment of the recording medium P in the width direction. Then, the holding rollers 31 perform the lateral registration correction on the recording medium P based on a detection result by the CIS 37.

The photosensor 38 is arranged downstream of the registration rollers 33 in the conveying direction of the recording medium P. The photosensor 38 optically detects the leading edge of the recording medium P conveyed from the registration rollers 33. A timing at which the recording medium P is conveyed by the registration rollers 33 toward the secondary transfer nip is finely adjusted based on a detection result by the photosensor 38.

As shown in FIG. 5A, when the recording medium P is fed from the feeding unit 26 to the feeding path K1, the recording medium P is conveyed toward the junction X (in a direction indicated by a dashed arrow in FIG. 5A) in accordance with rotation of conveying rollers.

As shown in FIG. 5B, when the recording medium P reaches the junction X, the recording medium P is conveyed to the upstream side K2a (in a direction indicated by a dashed arrow in FIG. 5B) by the switching claw. At this time, the conveying rollers 28 are rotated in the forward direction.

After the trailing edge of the recording medium P is conveyed within the upstream side K2a, as shown in FIG. 5C, the conveying rollers 28 are rotated in the backward direction to reverse (switch back) the conveying direction of the recording medium P, so that the recording medium P is conveyed toward the downstream side K2b. At this time, although not shown, the switching claw is rotated in such a direction that the recording medium P is conveyed from the upstream side K2a to the downstream side K2b.

As shown in FIG. 6A, the recording medium P is then conveyed toward the contact member 32 (in a direction indicated by a dashed arrow in FIG. 6A) in accordance with rotation of the conveying rollers 28 in a direction indicated by an arrow R1 (in the backward direction). The holding rollers 31 move in a direction (a direction indicated by an arrow A1) to open the straight conveying path K2. The contact member 32 moves in a direction (a direction indicated by an arrow B1) to close the straight conveying path K2.

As shown in FIG. 6B, the leading edge of the recording medium P is brought in contact with the contact member 32, and the recording medium P stops moving. As shown in FIG. 6C, the conveying rollers 28 stop rotating, and the holding rollers 31 move in a direction (a direction indicated by an arrow A2 ) to hold the recording medium P. At this time, a part of the recording medium P is bent.

As described above, the leading edge of the recording medium P is in contact with the contact member 32, so that the skew (slanting) of the recording medium P is corrected. Specifically, if the recording medium P is conveyed at an oblique angle with respect to the conveying direction (if the recording medium P is skewed), one end of the leading edge of the recording medium P is brought into contact with the contact member 32, and the leading edge is moved toward the contact member 32 with the one end as a pivot, so that the other end of the leading edge is brought into contact with the contact member 32. Thus, the skew of the recording medium P is corrected.

Furthermore, the longitudinal registration of the recording medium P is corrected. Specifically, the holding rollers 31 are driven to rotate to convey the recording medium P toward the registration rollers 33 in synchronization with a timing of transferring a color image formed on the intermediate transfer belt 8.

As shown in FIG. 6D, the conveying rollers 28 move in a direction (a direction indicated by an arrow C1) to open the straight conveying path K2, and the contact member 32 moves in a direction (a direction indicated by an arrow B2) to open the straight conveying path K2. That is, the recording medium P is held by only the holding rollers 31.

As shown in FIG. 7A, the recording medium P is conveyed toward the registration rollers 33 (in a direction indicated by a dashed arrow in FIG. 7A) in accordance with rotation of the holding rollers 31 in a direction indicated by an arrow R2. Then, the CIS 37 detects a degree of misalignment of the recording medium P in the width direction, and the holding rollers 31 move in a direction perpendicular to a sheet surface of FIG. 7A (a direction indicated by reference numeral S) to offset the misalignment. For example, as shown in FIG. 4, if the lateral registration of the recording medium P is shifted to the right in FIG. 4 by 3 millimeters, the holding rollers 31 holding the recording medium P is shifted to the left in FIG. 4 by 3 millimeters.

After the lateral registration of the recording medium P is corrected, as shown in FIG. 7B, the leading edge of the recording medium P is brought into contact with the registration rollers 33 and the recording medium P stops moving. The conveying rollers 28 move in a direction (a direction indicated by an arrow C2) to close the straight conveying path K2, so that the conveying rollers 28 stand by for the next recording medium.

As shown in FIG. 7C, the conveying rollers 28 start to rotate (in the forward direction indicated by an arrow R0), and the holding rollers 31 move in a direction (a direction indicated by an arrow A1) to release the recording medium P. When the registration rollers 33 are rotated to convey the recording medium P, and the photosensor 38 detects the leading edge of the recording medium P, the registration rollers 33 temporarily stop rotating.

Then, the longitudinal registration of the recording medium P is corrected. Specifically, as shown in FIG. 7D, the recording medium P is conveyed to the secondary transfer nip in synchronization with a timing of transferring a color image formed on the intermediate transfer belt 8. Thus, a color image is transferred onto a correct position of the recording medium P.

The registration rollers 33 are configured such that its rotation speed can be varied by a variable drive motor (not shown). With this configuration, a speed at which the recording medium P is conveyed from the registration rollers 33 to the secondary transfer nip can be adjusted, and therefore the longitudinal registration correction can be performed with higher precision.

The contact member 32 moves in a direction (a direction indicated by an arrow B1) to close the straight conveying path K2, so that the contact member 32 stands by for the skew correction of the next recording medium P′ conveyed by the conveying rollers 28.

As described above, in the image forming apparatus 100, the feeding path K1 links to the midstream (the junction X) of the straight conveying path K2 including the registration correcting unit 30, and the feeding path K1 is arranged on the inner side of the image forming apparatus 100 than the end of the upstream side K2a of the straight conveying path K2 is. With this arrangement, it is possible to reduce the size of the image forming apparatus 100 in the lateral direction.

FIG. 10 is a schematic diagram of a conventional image forming apparatus near a conveying path. A conveying path leading from the feeding unit 26 to the opposing roller 12B and the secondary transfer roller 19 (the image transfer unit) is formed of a curved conveying path K100 and a straight conveying path K200. As a result, the size of the image forming apparatus becomes large in the lateral direction.

As shown in FIG. 1, the second feeding path K10 is arranged to convey the recording medium P from the LCT 200 arranged outside of the image forming apparatus 100 to the junction X. With this configuration, even in a case where the recording medium P is conveyed from the LCT 200, the size of the image forming apparatus 100 can be reduced in the lateral direction. Although the LCT 200 is arranged outside of the image forming apparatus 100 according to the embodiment, a manual feeding unit can be arranged outside of the image forming apparatus 100. In such a case, the recording medium P is conveyed from the manual feeding unit to the junction X through the second feeding path K10.

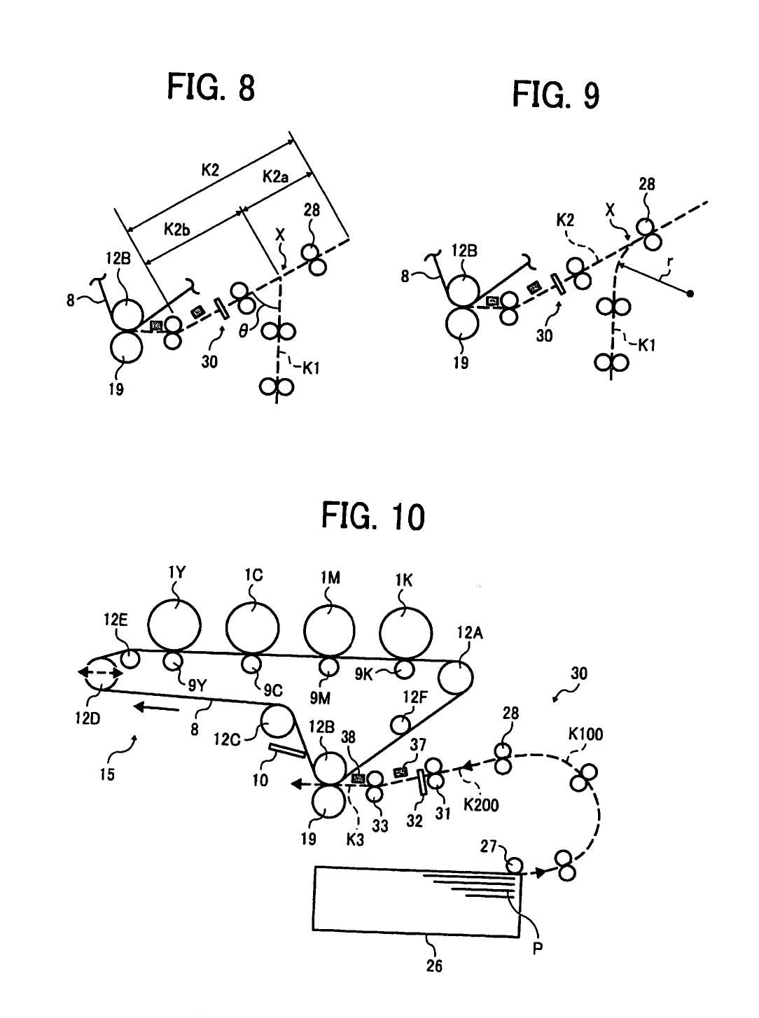

FIG. 8 is a schematic diagram of the feeding path K1 and the straight conveying path K2. It is preferable that the feeding path K1 and the straight conveying path K2 are arranged such that an angle θ defined by the feeding path K1 and the straight conveying path K2 (the downstream side K2b) is set to be less than 90 degrees (preferably, less than 45 degrees). With this arrangement, an angle at which the recording medium P enters the upstream side K2a from the feeding path K1 is an obtuse angle, and therefore possibility of paper jam can be reduced at the junction X. Especially, because the conveying direction of the recording medium P is reversed on the upstream side K2a, paper jam can occur in the straight conveying path K2. Therefore, the configuration for preventing the paper jam is useful.

Furthermore, it is preferable that the feeding path K1 and the straight conveying path K2 are arranged such that a length of the upstream side K2a is equal to or less than one-half of a length of the straight conveying path K2 (preferably, equal to or less than one-third). With this configuration, a sufficient length of the downstream side K2b can be secured while the size of the image forming apparatus 100 is reduced, and therefore the productivity can be improved upon operation of continuously conveying recording media.

FIG. 9 is a schematic diagram of another example of the feeding path K1 and the straight conveying path K2. As shown in FIG. 9, the feeding path K1 near the junction X can be formed in a round shape. In such a case, it is preferable that a curvature r of the feeding path K1 near the junction X is set to be equal to or more than R100 [mm] (preferably, equal to or more than R200 [mm]). Thus, the recording medium P can be conveyed from the feeding path K1 to the upstream side K2a in a smooth manner, and possibility of paper jam can be reduced at the junction X. Especially, because the conveying direction of the recording medium P is reversed on the upstream side K2a, paper jam can occur in the straight conveying path K2. Therefore, the configuration for preventing the paper jam is useful.

As described above, in the image forming apparatus 100, the recording medium P is conveyed from the feeding unit 26 to the junction X arranged at the midstream of the straight conveying path K2 including the registration correcting unit 30, and after the recording medium P is conveyed in the straight conveying path K2 in such a direction that the recording medium P is moved away from the registration correcting unit 30, the conveying direction of the recording medium P is reversed to convey the recording medium P toward the registration correcting unit 30. Therefore, the lateral registration correction can be performed with high precision, and the size of the image forming apparatus 100 can be reduced.

In the embodiment, the present invention is applied to the image forming apparatus using the intermediate transfer belt 8 as the image carrier. However, the present invention can be applied to an image forming apparatus using a photosensitive belt, a photosensitive drum, or the like, as the image carrier. In such a case, a junction is arranged at a midstream of a straight conveying path for conveying a recording medium toward an image transfer unit, and a feeding path links to the junction, so that the same effect as in the embodiment can be achieved.

The present invention is not limited to the embodiment, but modifications can be made as appropriate within a scope of technical ideas of the present invention. Moreover, the number of components, and the position, the shape, or the like, of the component are not limited to those in the embodiment, but those can be modified in a preferable manner.

According to an aspect of the present invention, it is possible to provide an image forming apparatus in which lateral registration of a recording medium can be corrected with high precision, and the size of the image forming apparatus can be reduced.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus comprising:
an image transfer unit that transfers an image carried on an image carrier onto a recording medium;
a feeding unit that feeds the recording medium;
a conveying path that conveys a recording medium from the feeding unit to the image transfer unit, the conveying path including a first conveying path, a second conveying path, and a coupling unit that couples the first conveying path and the second conveying path to each other, the first conveying path connecting the feeding unit to the coupling unit, the second conveying path connecting the coupling unit to the image transfer unit, and the first conveying path being substantially straight;
a lateral registration correcting unit arranged in the second conveying path downstream of the coupling unit and that corrects misalignment of the recording medium in a width direction of the recording medium when the recording medium is being conveyed through the second conveying path; and
a reversing unit that receives the recording medium conveyed to the coupling unit through the first conveying path, reverses a conveying direction of the recording medium and feeds the recording medium to the coupling unit so that the recording medium is conveyed to the image transfer unit through the second conveying path, wherein
the first conveying path is arranged on an inner side of the image forming apparatus than an end of the second conveying path upstream of the coupling unit.

2. The image forming apparatus according to claim 1, wherein the reversing unit is arranged in the second conveying path upstream of the coupling unit than the lateral registration correcting unit.

3. The image forming apparatus according to claim 1, wherein the feeding unit is arranged under the second conveying path.

4. The image forming apparatus according to claim 1, wherein the second conveying path is tilted such that an upstream end is located at a higher position than a downstream end of the second conveying path.

5. The image forming apparatus according to claim 1, further comprising a third conveying path that is arranged upstream of the second conveying path.

6. The image forming apparatus according to claim 1, further comprising an opening that is arranged upstream of the second conveying path and that is formed to open to outside of the image forming apparatus.

7. The image forming apparatus according to claim 6, wherein the opening is formed on an upper side of the image forming apparatus.

8. The image forming apparatus according to claim 1, further comprising a fourth feeding path that connects the coupling unit to an external feeding device arranged outside of the image forming apparatus.
